(19) United States
(12) Patent Application Publication
(10) Pub. No.: US 2010/0015520 A1
(43) Pub. Date: Jan. 21, 2010

(54) BATTERY COVER LATCHING STRUCTURE FOR PORTABLE ELECTRONIC DEVICE

(75) Inventor: JIN-LIAN CHEN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/327,500

(22) Filed: Dec. 3, 2008

(30) Foreign Application Priority Data
Jul. 18, 2008 (CN) 200810302802.2

(51) Int. Cl. H01M 2/04

(52) U.S. Cl. 429/163; 429/175

(57) ABSTRACT

A battery cover latching structure (30) attached to a battery cover (20) of a portable electronic device (100), which comprises a fixing section (32) and a latching section (34). The fixing section (32) is used to attach the latching structure (30) to the battery cover (20). The latching section (34) extends from the fixing section (32) and has a surface (3422) facing the battery cover (20). The latching section (34) has a block (3424) protruding from the surface (3422) and configured for contacting the battery cover (20).

### BACKGROUND

1. Field of the Invention

The invention generally relates to battery cover latching structures, and particularly to battery cover latching structures used in portable electronic devices.

2. Description of Related Art

Batteries are widely used in portable electronic devices, such as personal digital assistants (PDAs), cellular phones, etc. A typical latching structure is used to latch a battery cover to the electronic device and thus to secure the battery between the battery cover and the electronic device. The battery cover may be made of metallic material.

Metallic battery covers may generate static electricity harmful to the battery or other electronic components in the electronic device. To remove the static electricity, the latching structure may connect to grounding points of the electronic device. However, as the electronic devices become more compact, the latching structure generally also has to be made more compact. As a result, the latching structure may not have sufficient structural strength to connect to the grounding points for effectively removing the static electricity.

Therefore, there is a room for improvement within the art.

### BRIEF DESCRIPTION OF THE DRAWINGS

Many aspects of the exemplary battery cover latching structure for portable electronic device can be better understood with reference to the following drawings. These drawings are not necessarily drawn to scale, the emphasis instead being placed upon clearly illustrating the principles of the exemplary battery cover latching structure and portable electronic device. Moreover, in the drawings like reference numerals designate corresponding parts throughout the several views. Wherever possible, the same reference numbers are used throughout the drawings to refer to the same or like elements of an embodiment.

FIG. 1 is a schematic and assembled view of a portable electronic device with a battery cover latching structure according to an exemplary embodiment.

FIG. 2 is a schematic and exploded view of the portable electronic device shown in FIG. 1.

FIG. 3 is a schematic and partially enlarged cross-sectional view of the portable electronic device shown in FIG. 1.

FIG. 4 is a partial and enlarged view of the portable electronic device in FIG. 2, during a latching structure assembly to a battery cover thereof.

FIG. 5 is an enlarged view of a battery cover shown in FIG. 2.

### DETAILED DESCRIPTION OF THE EMBODIMENTS

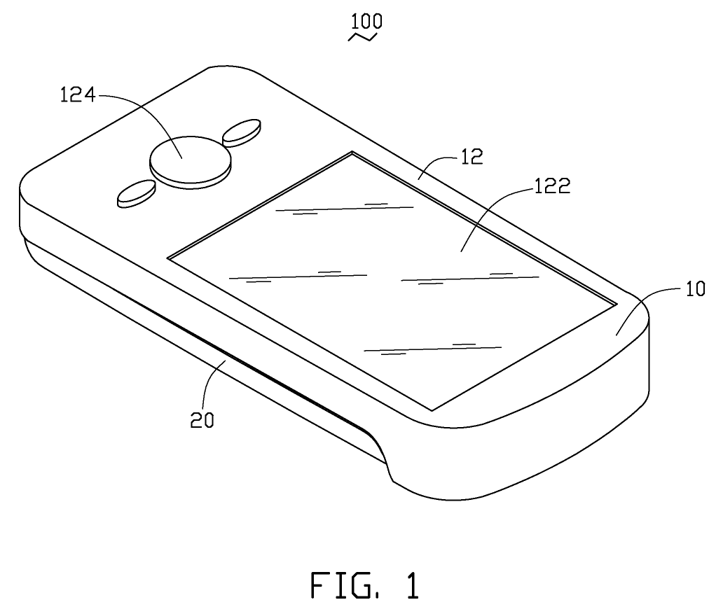

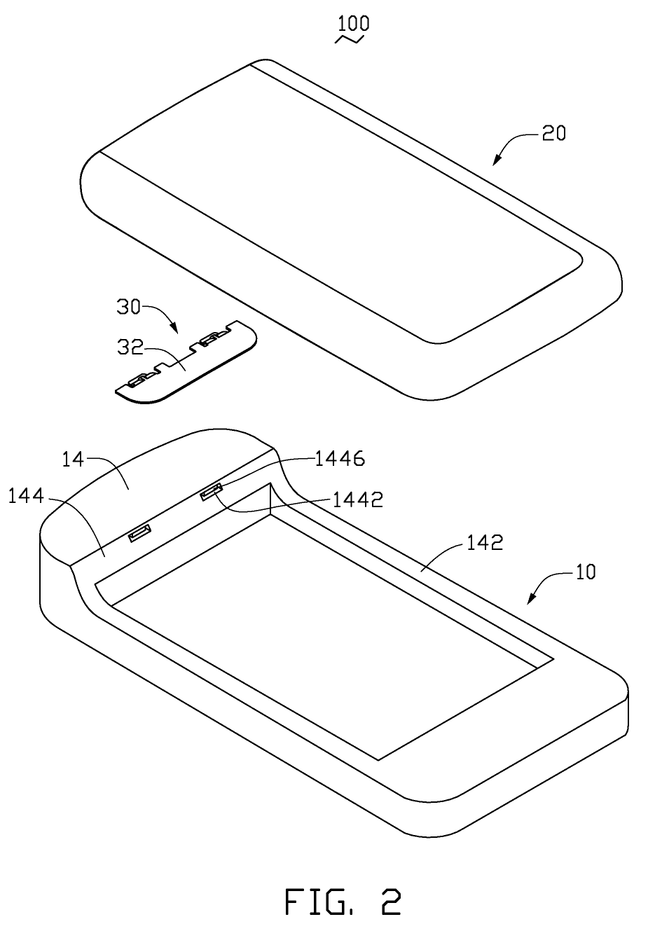

FIGS. 1 and 2 show an exemplary portable electronic device 100 (such as a mobile phone) including a main body 10, a battery cover 20, and a battery cover latching structure 30. The battery cover 20 can be detachably latched to the main body 10 by the battery cover latching structure 30.

The main body 10 includes a first surface 12 and a second surface 14 opposite to the first surface 12. The first surface 12 may have a display 122 and a plurality of keys 124 formed thereon.

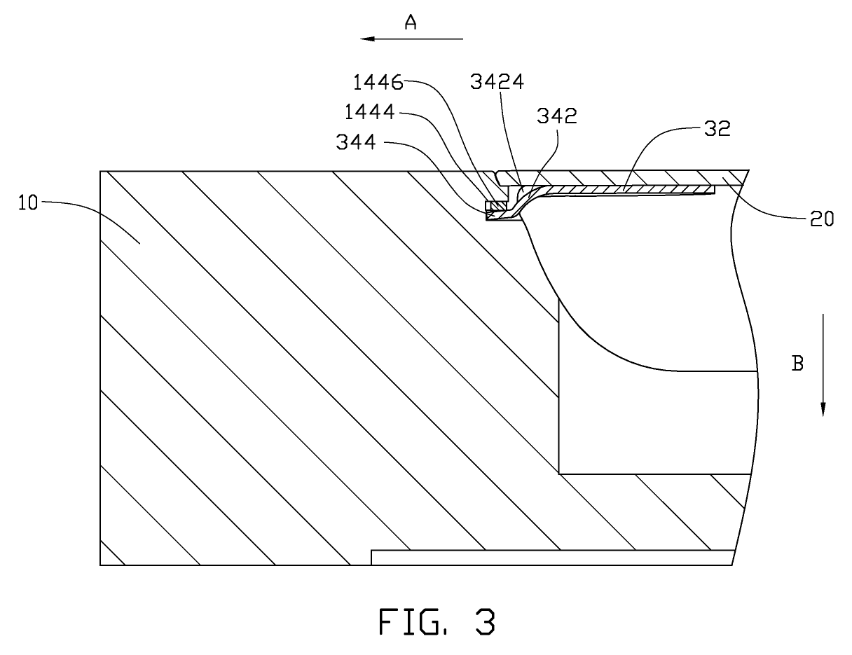

The main body 10 has a recess 142 defined in the second surface 14 for receiving the battery cover 20, and further defines a sidewall 144. Referring to FIG. 2, the sidewall 144 defines two slots 1442, and each slot 1442 has an upper wall 1444 (FIG. 3). Each upper wall 1444 has a metallic grounding portion 1446 protruding into the slot 1442.

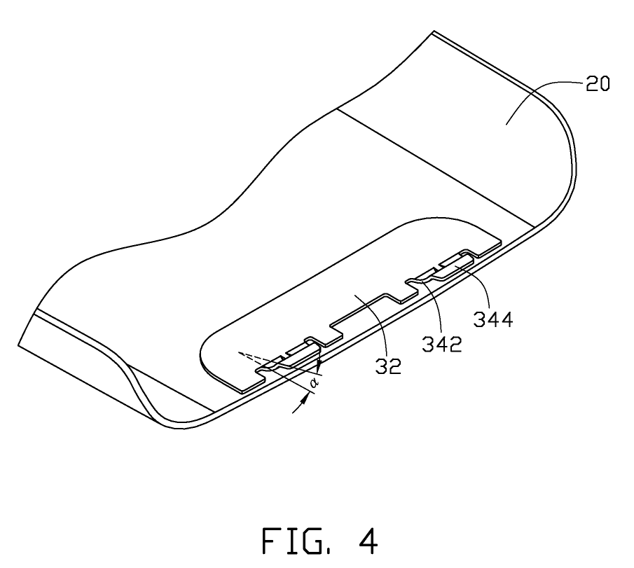

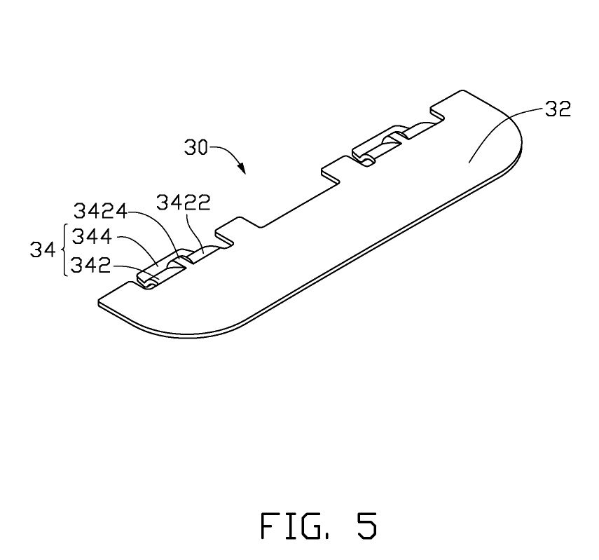

Referring to FIGS. 4 and 5, the battery cover latching structure 30 is substantially a sheet with elastic portions, and includes a fixing section 32 and two latching sections 34 extending from near opposite ends of one side of the fixing section 32. The fixing section 32 is configured for fixing (e.g., welding) the battery cover latching structure 30 to the battery cover 20. Each latching section 34 includes a connecting portion 342 extending away from an edge of the fixing section 32, and a resisting portion 344 extending from a distal end of the connecting portion 342. The resisting portions 344 are slightly bent at an acute angle to the plane of the fixing section 32. The battery cover latching structure 30 may be made of metallic material for electrically connecting the battery cover 20 to the grounding portions 1446. The metallic material may be selected from the group of aluminium, iron, and magnesium.

The connecting portion 342 includes a third surface 3422 for facing towards the battery cover 20. The connecting portion 342 has a block 3424 protruding from the third surface 3422 to improve the structural strength of the connecting portion 342. The block 3424 is adjacent to and substantially coplanar with the plane of the fixing section 32. Referring to FIG. 3, the block 3424 contacts the battery cover 20 to support the latching section 34 against the battery cover 20, thereby reducing chances of deformation of battery cover latching structure 30.

Referring to FIG. 3, since the resisting portions 344 are bent at a acute angle, when the resisting portions 344 are inserted into the slots 1442 in the direction of arrow A, the latching sections 34 may deform and be biased in the direction of arrow B. As such, structural strength of the connecting portion 342 is enhanced by the block 3424, accordingly, the force overcoming the biasing of the latching sections 34 may be increased. Conversely, the returning force of the latching sections 34 may be increased. Thus, the resisting portions 344 may more effectively contact the grounding portions 1446 to allow removal of the static electricity of the battery cover 20.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover latching structure attached to a battery cover of a portable electronic device, comprising:
a fixing section used to attach the latching structure to the battery cover; and
a latching section extending from the fixing section and having a surface facing the battery cover, the latching section having a block extending from the surface and configured for contacting the battery cover.

2. The battery cover latching structure as claimed in claim 1, wherein the latching structure is made of metallic material.

3. The battery cover latching structure as claimed in claim 2, wherein the metallic material is selected from the group consisting of aluminum, iron, and magnesium.

4. The battery cover latching structure as claimed in claim 1, wherein the latching section has a connecting portion extending away from an edge of the fixing section and a resisting portion extending from a distal end of the connecting portion, and the resisting portion is bent at an acute angle relative to a plane of the fixing section.

5. The battery cover latching structure as claimed in claim 4, wherein the block protrudes from the connecting portion.

6. The battery cover latching structure as claimed in claim 4, the resisting portion is located opposite to the fixing section.

7. A portable electronic device, comprising:
a main body having a grounding portion;
a battery cover latched to the main body; and
a latching structure including a fixing section and a latching section, the fixing section used to attach the latching structure to the battery cover, the latching section extending from the fixing section and having a surface facing the battery cover, the latching section latched with the main body and elastically biased against the grounding portion, the latching section having a block protruding from the surface and configured for contacting the battery cover.

8. The portable electronic device as claimed in claim 7, wherein the latching section has a connecting portion extending away from an edge of the fixing section and a resisting portion extending from a distal end of the connecting portion, and the resisting portion is bent at an acute angle to the fixing section.

9. The portable electronic device as claimed in claim 8, wherein the block protrudes from the connecting portion.

10. The portable electronic device as claimed in claim 8, wherein the base defines a slot for latching with the resisting portion.

11. The portable electronic device as claimed in claim 10, wherein the slot has an upper wall defined therein, the grounding portions protruding from the upper wall.

12. The battery cover latching structure as claimed in claim 7, wherein the latching structure is made of metallic material.

13. The battery cover latching structure as claimed in claim 12, wherein the metallic material is selected from the group of aluminum, iron, and magnesium.
